(19) United States
(12) Patent Application Publication
(10) Pub. No.: US 2019/0361218 A1
(43) Pub. Date: Nov. 28, 2019

(54) IMAGING SYSTEMS WITH IMPROVED THREAD LIFE

(71) Applicant: GE Inspection Technologies, LP, Lewistown, PA (US)

(72) Inventor: Andrew Tang, Lewistown, PA (US)

(21) Appl. No.: 15/988,704

(22) Filed: May 24, 2018

(51) Int. Cl. G02B 23/24; H04N 5/225

(52) U.S. Cl. CPC G02B 23/2484; H04N 2005/2255; G02B 23/2492; H04N 5/2252

(57) ABSTRACT

Systems, methods, and devices are provided that facilitate reducing wear of threads of a camera head of an imaging system (e.g., a borescope), thereby increasing the lifespan of an imaging system. In some embodiments, an imaging system is provided that includes a camera head made of anodized TiAl₆V₄ and coated with a solid film lubricant. The imaging system can also include a probe tip made of 303 stainless steel and coated with a diamond-line carbon coating. By using a camera head made of anodized TiAl₆V₄ and coated with a SFL in combination with a probe tip made of 303 SS and coated with a DLC, wear on threads of the camera head can be reduced, thereby increasing the lifespan of the imaging system.

### BACKGROUND

Imaging systems such as video borescopes are often used for visual inspection work in areas that would otherwise be inaccessible, or in areas where accessibility may require destructive, time consuming, and/or expensive disassembly of components. For example, borescopes can be used for visual inspection of aircraft engines, aeroderivative industrial gas turbines, steam turbines, diesel engines, automotive engines, etc.

Video borescopes can include a camera head that has a miniature camera. The camera head can include interchangeable probe tips that removably couple to the camera head, e.g., using threads or other mating techniques. In some cases, the probe tips function to protect the camera head and the camera assembly or to modify optical characteristics of the borescope. For example, different probe tips can provide different depths of field, fields of view, and directions of view to the borescope. The camera head, which is positioned at the end of a flexible probe assembly, can be coupled to a controller which can control operation of the probe assembly and process images/video from camera assembly.

### SUMMARY

Throughout the lifetime of the borescope, probe tips can be changed a number of times to provide protection to the camera head and/or to provide different optical characteristics for different situations. However, over time, threading and unthreading probe tips onto the camera head can wear out the threads of the camera head.

Systems, devices, and methods for improved thread life of camera heads of imaging systems are provided. In one embodiment, an imaging apparatus is provided that includes a housing having an elongate body extending distally therefrom. The elongate body can include a camera head at a distal end thereof. The camera head can have a camera therein that can be configured to obtain images. The camera head can also include threads. The imaging apparatus can further include at least one probe tip that can be configured to removably mate with the camera head, e.g., using threads of other mating techniques. The imaging apparatus can further include a diamond-like carbon coating on the mating feature, such as on the threads of the probe tip.

One or more of the following features can be included in any feasible combination. In one embodiment, the apparatus can include a solid film lubricant coating on the threads of the camera head and/or on the body of the camera head. The solid film lubricant coating can be, for example, a heat cured, resin bonded solid film lubricant coating. In certain exemplary embodiments, the solid film lubricant coating can be Slickote® DL100.

In another embodiment, the camera head can be formed from an anodized titanium alloy, which can be, for example, TiAl₆V₄.

In one embodiment, the diamond-like carbon coating can be a metal-containing coating. In another embodiment, the diamond-like carbon coating can be Titankote™ C12. In yet another embodiment, the diamond-like carbon coating can have a thickness in a range of about 1 μm to 5 μm.

In other aspects, a body of the probe tip can be at least partially coated with a diamond-like carbon coating.

In another embodiment, the threads of the probe tip can be formed from stainless steel. In some embodiments, the stainless steel can be 303 stainless steel.

In certain exemplary embodiments, the threads of the camera head can be formed from anodized titanium alloy, and the threads of the probe tip can be formed from stainless steel. The threads of the camera head can include a solid film lubricant coating.

In other embodiments, the threads of the camera head can be formed on an external surface of the camera head, and the threads of the probe tip can be formed within a lumen in the probe tip. The lumen in the probe tip can be configured to receive at least a portion of the camera head therein.

In another aspect, an imaging system is provided that can include a housing having an elongate body extending distally therefrom. The elongate body can include a camera head at a distal end thereof with an imaging device configured to acquire images and to transmit data characterizing the images. The housing can include a controller configured to control operation of the imaging device. The system can also include at least one probe tip that can be detachably mateable to the camera head. The camera head can have anodized titanium alloy threads that can engage corresponding stainless steel threads on the probe tip. The threads on the camera head can be coated with a solid film lubricant coating and the threads on the probe tip can be coated with a diamond-like carbon coating.

One or more of the following features can be included in any feasible combination. In one embodiment, the anodized titanium alloy threads can be formed from a titanium alloy that can include titanium, aluminum, and vanadium. In another embodiment, the stainless steel threads can be 303 stainless steel. In yet another embodiment, the diamond-like carbon coating can be Titankote™ C12. In some embodiments, the solid film lubricant coating can be Slickote® DL100.

### DESCRIPTION OF DRAWINGS

FIG. 1 is a side front view of one exemplary embodiment of an imaging system;

FIG. 2 is an exploded perspective view of a camera assembly of the imaging system shown in FIG. 1;

FIG. 3 is a perspective view of one exemplary embodiment of a testing system that can be used to test thread wear for various combinations of materials and coatings used for a camera head and the probe tip of an imaging system; and

FIG. 4 is a plot that illustrates an average number of cycles until failure for various combinations of materials and coatings tested using the testing system shown in FIG. 3.

### DETAILED DESCRIPTION

Certain exemplary embodiments will now be described to provide an overall understanding of the principles of the structure, function, manufacture, and use of the systems, devices, and methods disclosed herein. One or more examples of these embodiments are illustrated in the accompanying drawings.

As explained above, throughout the lifetime of a borescope, probe tips can be changed a number of times to provide protection to the camera head and/or to provide different optical characteristics for different situations. Over time, threading and unthreading probe tips onto the camera head can wear out the threads of the camera head. Systems, methods, and devices are thus provided for reducing thread wear on camera heads of borescopes. In particular, a borescope is provided that includes a camera head made of an anodized titanium alloy and a probe tip made of stainless steel. Threads of the probe tip can be coated with a diamond-like carbon coating, and threads of the camera head can be coated with a heat cured, resin bonded, solid film lubricant coating. The combination of materials, including the anodized titanium alloy coated with the dry lubricant and the stainless steel coated with the diamond-like carbon coating, can reduce wear on threads of the camera head of the borescope, thereby increasing the lifespan of the device.

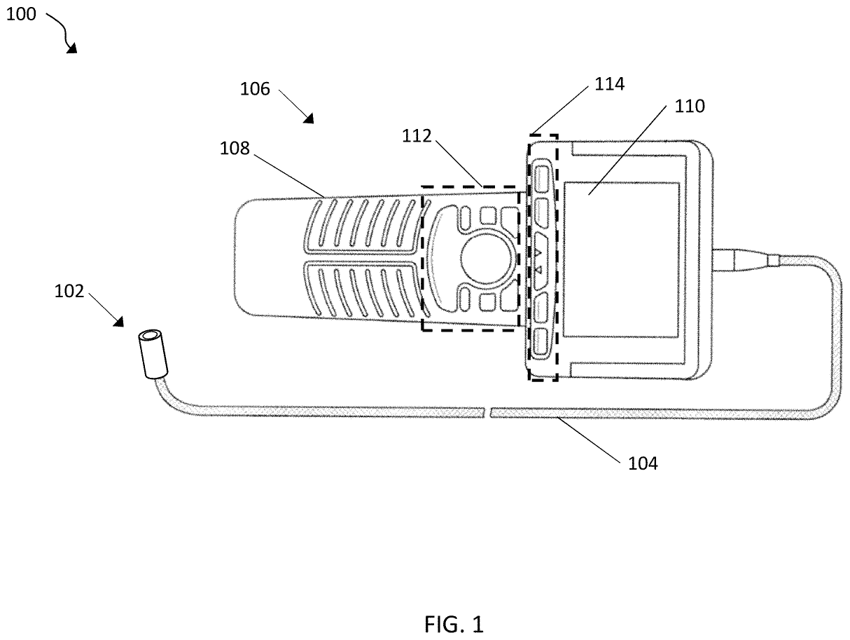

FIG. 1 shows an exemplary embodiment of an imaging system 100 that can be configured to facilitate visual inspection of areas of systems/devices that would otherwise be inaccessible, or of areas where accessibility may require destructive, time consuming, and/or expensive disassembly of components. In the illustrated embodiment the imaging system 100 is a borescope, however a person skilled in the art will appreciate that the combination of materials disclosed herein can be used with any imaging system or in other fields of use where reduced wear is required for parts that are removably mated to one another. In the illustrated example, the imaging system 100 includes a camera assembly 102 positioned at a distal end of a flexible probe assembly 104, and a controller 106 operatively coupled to the camera assembly 102.

The flexible probe assembly 104 can be configured to facilitate positioning the camera assembly 102 at a desired location and to transmit signals between the camera assembly 102 and the controller 106. For example, the probe assembly 104 can include wires, articulation elements, fiber optic bundles, etc. that can facilitate positioning the camera assembly 102 and transmitting signals between the camera assembly 102 and the controller 106. The camera assembly 102 can be configured to acquire images of an area of a system/device and to transmit data characterizing the images to the controller 106 via the flexible probe assembly 104.

The controller 106 can include at least one data processor, and the controller 106 can be configured to control the position of the camera assembly 102 and to process data from the camera assembly 102 characterizing images. In the illustrated example, the controller 106 includes a handle 108 and a display 110. The handle 108 can be configured to allow a user to grasp the controller 106. The display 110 can be configured to display images acquired by the camera assembly 102. The controller 106 can also include button panels 112, 114 that can be configured to allow a user to control the position of the camera assembly 102, as well as select options to control operation of the camera assembly 102 and/or the display 110.

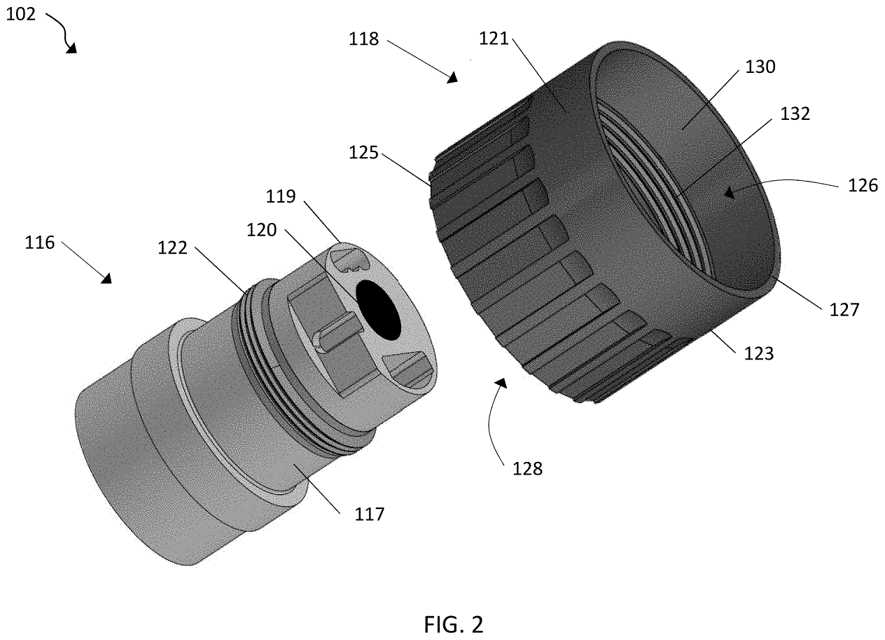

FIG. 2 shows an exploded view of the camera assembly 102. As shown, the camera assembly 102 can include a camera head 116 and a probe tip 118. The probe tip 118 can be configured to detachably couple to the camera head 116. In the illustrated embodiment, the camera head 116 has a cylindrical body 117 and includes a camera 120, or imaging device, that can be configured to acquire images and to provide data characterizing the images to the controller 106. The camera 120 can be positioned at a distal end 119 of the body 117 of the camera head 116. An outer surface of the body 117 of the camera head 116 can include threads 122 that can facilitate coupling the probe tip 118 to the camera head 116.

As further shown in FIG. 2, the probe tip 118 has a cylindrical body 121 having an outer wall 123 extending between a proximal end 125 and a distal end 127 of the probe tip 118. The body 121 of the probe tip 118 can also include an inner lumen 126 that can extend distally from an opening 128 at a proximal end 125 of the body 121. The inner lumen 126 can be configured to receive at least a portion of the camera head 116. An inner wall 130 of the body 121 can include threads 132 that can be configured to mate with the threads 122 of the camera head 116 such that the probe tip 118 can be removably coupled to the camera head 116. In some embodiments, the body 121 can have an outer diameter of about 6.1 mm, however the diameter can vary depending on the configuration of the device.

The probe tip 118 can also include an optical element (not shown) that can be configured to modify optical characteristics of the imaging system 100. For example, the optical element can adjust a depth of field, field of view, and/or a direction of view of the camera 120. In some embodiments, the optical element can be positioned at, or adjacent to, the distal end 127 of the body 121 of the probe tip 118. In other embodiments, the optical element can be positioned between the proximal and distal ends 125, 127 of the body 121 of the probe tip 118.

Exemplary embodiments of a borescope and components that can be included in the probe tip 118 are disclosed, by way of non-limiting example, in U.S. Pat. No. 7,821,649 entitled “Fringe Projection System and Method for a Probe Suitable for Phase-Shift Analysis,” and U.S. Pat. No. 7,170,677 entitled “Stereo-Measurement Borescope with 3-D Viewing,” which are hereby incorporated by reference in their entities.

A person skilled in the art will appreciate that the camera head 116 and probe tip 118 can have a variety of other configurations, including various shapes and sizes. Moreover the mating connection can also vary. For example, the camera head can have a lumen with threads formed on an inner surface thereof, and the probe tip can have threads on an external surface thereof for mating with the internal threads in the camera head. In other aspects, other mating techniques, such as a snap-fit or interference fit can be used as an alternative to or in addition to threads.

Throughout the lifetime of the imaging system 100, probe tips (e.g., probe tip 118) can be changed a number of times to provide protection to the camera head 116 and/or to provide different optical characteristics for different situations. Over time, threading and unthreading probe tips onto the camera head 116 can wear out the threads 122 of the camera head 116. In some cases, if the threads 122 of the camera head 116 wear out, the entire imaging system 100 may need to be replaced.

The materials that the bodies 121, 117 of the probe tip 118 and the camera head 116 are made of can affect the amount of wear that the threads 122 experience. For example, wear on the threads 122 can be reduced by making the body 117 of the camera head 116, and/or the threads 122 of the body 117, out of a harder material than that which is used for the body 121 of the probe tip 118. In one exemplary embodiment, the body 117 of the camera head 116, or the threads 122 of the body 117, can be made of an anodized titanium alloy, and the body 121 of the probe tip 118, or the threads 132 of the body 121, can be made of a stainless steel alloy. One exemplary embodiment of an anodized titanium alloy is TiAl₆V₄ and one exemplary embodiment of a stainless steel alloy is 303 SS.

TiAl₆V₄ is a “Grade 5” heat treatable titanium alloy, and it can have a Brinell hardness of approximately 265, a Rockwell C hardness of approximately 36, and a Vickers hardness in the range of approximately 351-369. The primary components of TiAl₆V₄ are titanium, aluminum, and vanadium. However, TiAl₆V₄ can include some amounts of other elements such as, e.g., iron, hydrogen, oxygen, nitrogen, and/or carbon. Anodizing the TiAl₆V₄ can provide increased resistance to corrosion and wear (e.g., by reducing galling), and can also provide facilitate improved adhesion of coatings.

303 SS is a machinable, non-magnetic, austenitic stainless steel. The primary components of 303 SS are iron, chromium, and nickel. However, 303 SS can include some amounts of other elements such as, e.g., carbon, silicon, manganese, phosphorus, sulfur, and/or molybdenum. 303 SS can have a Brinell hardness in a range of approximately 230-262, a Rockwell C hardness of approximately 19, and a Vickers hardness of approximately 240. Therefore, 303 SS has a lower hardness than TiAl₆V₄.

In other embodiments, the body 121 of the probe tip 118, or the threads 132 of the body 121, can be made of a stainless steel alloy such as 304 SS. 304 SS can generally be similar to 303 SS but it can include less carbon, silicon, phosphorus, sulfur, and molybdenum. 304 SS can have a Brinell hardness in the range of approximately 123-201, and a Vickers hardness of approximately 129. By making the body 117 of the camera head 116 out of a material (e.g., TiAl₆V₄) that is harder than the material (e.g., 303 SS, or 304 SS) used to form the body 121 of the probe tip 118, wear of the threads 122 of the camera head 116 can be reduced. Other materials that the camera head 116 and/or probe tip can be made of include bronze-aluminum mixtures, nitrided TiAl₆V₄, and various stainless steel alloys (e.g., any 300 series or 400 series stainless steel alloy). In some cases, the materials can be heat treated.

In some cases, thread wear can be further reduced by applying specific coatings to the contact surfaces (e.g., the threads 122, 132) of the camera head 116 and/or the probe tip 118, respectively. For example, in an exemplary embodiment, the body 117 of the camera head 116, or the threads 122 of the body 117, can be coated with a solid film lubricant (SFL) coating. SFL coatings can be paint-like coatings of fine particles of lubricating pigment blended with a binder and other additives. The use of a SFL coating can reduce friction between contact surfaces (e.g., the threads 122, 132) of the camera head 116 and the probe tip 118. By reducing friction between the camera head 116 and the probe tip 118, the SFL coating can reduce wear and prevent galling, corrosion, and seizure of the camera head 116 and the probe tip 118. The lubricant can be applied to a substrate (e.g., the camera head 116 and/or the probe tip 118) by spray, dip, or brush methods. Once applied, the SFL coating can be cured, thereby creating a solid film which can repel water, reduce friction, and increase wear life of the substrate to which the coating has be applied. SFL coatings can also provide corrosion resistance. By way of non-limiting example, exemplary SFL coatings include molybdenum disulfide (MoS₂), polytetrafluoroethylene (PTFE), graphite, boron nitride, talc, calcium fluoride, talc, calcium fluoride, cerium fluoride, tungsten disulfide, and combinations thereof.

In some embodiments, the SFL coating can be a heat cured, resin bonded SFL. In an exemplary embodiment, the SFL coating can be Slickote® DL100, available from Specialty Coatings & Chemicals, Inc. in Los Angeles, Calif. Slickote® DL100 can include ethanol, methyl ethyl ketone, n-butanol, toluene, xylene, and antimony trioxide. Table 1 shows another exemplary composition of Slickote® DL100.

TABLE 1
Exemplary composition of Slickote ® DL100.

| Chemical Name | Composition (Weight %) |
|---|---|
| Denatured Ethanol | 40 |
| 2-Butanone | 35 |
| Propylene Glycol M Ether Acetate | 5 |
| Rubbing Alcohol | 5 |
| Methyl Alcohol | 5 |
| Formaldehyde in Solution | 0.1 |

Prior to applying the Slickote® DL100 to the body 117 of the camera head 116, and/or the threads 122 of the body 117, the body 117 can be cleaned with an abrasive. For example, the body 117 of the camera head 116 can be cleaned with a 180-220 grit aluminum oxide, and the body 117 can be anodized. The Slickote® DL100 can be mixed using, e.g., a mechanical paint shaker. The Slickote® DL100 can be reduced at a ratio of 2:1 using a Slickote® Reducer, or a 50/50 mixture by volume of ethanol and methyl ethyl ketone. The Slickote® DL100 can then be applied to surfaces of the camera head 116 as desired. For example, the Slickote® DL100 can be applied to the body 117 of the camera head 116, and/or the threads 122 of the body 117 by spraying it using a spray gun, by brushing, and/or by dipping. In some embodiments, the coating of Slickote® DL100 can have a thickness that is between approximately 0.008 mm and 0.013 mm. After the camera head 116 is coated with the Slickote® DL100, the camera head 116 can be left to air dry for approximately 30 minutes. The coating can then be heat cured at approximately 150° C. for 1 hour. Alternatively, and/or additionally, as another example, Slickote® DL100 can be applied to the body 121 (e.g., the threads 132) of the probe tip 118, in a manner similar to that described above with regard to the camera head 116.

As mentioned above, coatings can be applied to the probe tip 118 as well. For example, in an exemplary embodiment, the body 121 of the probe tip 118, and/or the threads 122 of the body 121, can be coated with a DLC coating. In some cases, the entire probe tip 118 can be coated with a DLC coating. DLC coatings can be formed when ionized and decomposed carbon or hydrocarbon species land on a surface of a substrate with energy in a range of approximately 10-300 eV. DLC coatings can possess high mechanical hardness, optical band gap, and electrical resistivity. DLC coatings can also be chemically inert and can have low friction and wear coefficients.

In an exemplary embodiment, the DLC coating can be a metal-containing DLC coating such as Titankote™ C12, available from Richter Precision, Inc. in East Petersburg, Pa. Titankote™ C12 can have a Vickers micro-hardness in the range of approximately 1000-2000, and can have a coefficient of friction of approximately 0.1.

DLC coatings can be applied to substrates (e.g., the probe tip 118) using any coating process. One exemplary process is a physical vapor deposition (PVD) coating process, including evaporation (e.g., using cathodic arc or electron beam sources), and sputtering (e.g., using magnetic enhanced sources or “magnetrons,” cylindrical or hollow sources). PVD coating processes can generally involve bombarding a substrate with a source material to coat the substrate. In some cases, during the PVD coating process, reactive gases such as, e.g., nitrogen, acetylene, and/or oxygen can be introduced into a vacuum chamber in which the coating process is being performed to create various compound coating compositions. This can result in a strong bond between the coating and the substrate, and can allow for tailored physical, structural, and tribological properties of the coating.

Evaporative PVD can generally involve heating a source material (e.g., a material to be deposited on a substrate) such that it evaporates and condenses on the substrate. Electron beam (E-beam) evaporative PVD, also referred to as E-beam PVD, can involve bombarding a source material with an E-beam such that the temperature of the source material increases. At a sufficient temperature, a portion of the source material can evaporate. The vapor portion of the source material can travel to a substrate that can be positioned adjacent to the source material, and can condense on the substrate to form a coating. Cathodic arc evaporative PVD, also referred to as arc-PVD, can generally involve using an electric arc to vaporize material from a cathode source. The vaporized source material can then condense on a substrate, which can be positioned adjacent to the source, to form a coating on the substrate. In some embodiments, evaporative PVD can be performed in vacuum at a working pressure in the range of approximately 10⁻²-10⁻⁷ Torr.

In an exemplary embodiment, magnetron sputtering (e.g., high-power impulse magnetron sputtering) PVD can be used to coat a substrate (e.g., the probe tip 118) with a DLC coating (e.g., Titankote™ C12). Magnetron sputtering is a plasma-based coating process in which a plasma is magnetically confined near a surface of a negatively charged source material (e.g., using a crossed-field electro-magnetic configuration). The cross-field electro-magnetic configuration can allow a dense magnetically confined plasma to be created near the surface of the negatively charged source material, also referred to as a target. Positively charged energetic ions from the plasma can collide with the negatively charged source material, and atoms from the source material can be ejected or “sputtered” onto the substrate, which can be adjacent to the source material. In some embodiments, magnetron sputtering PVD can be performed in vacuum at a working pressure in the range of approximately 10⁻²-10⁻⁴ Torr. The magnetron sputtering PVD can form a coating of Titankote™ C12 that is in the range of approximately 1-5 μm thick on the probe tip 118. The coating can be formed over the entirety of the probe tip 118, or on a portion of the probe tip 118 (e.g., the threads 132). The coating of Titankote™ C12 can be a defect-free intermetallic coating on the probe tip 118. In some embodiments, a DLC coating (e.g., Titankote™ C12) can also be applied to the camera head 116.

There are any number of SFL coatings that can be applied to the camera head 116 and/or to the probe tip 118. For example, Slickote® DL100, DL200, and DL300, available from Specialty Coatings & Chemicals, Inc. in Los Angeles, Calif., can be applied to the camera head 116 and the probe tip 118. As another example, there are any number of DLC coating that can be applied to the camera head 116 and/or to the probe tip 118. Other examples of DLC coating that can be applied to the camera head 116 and the probe tip 118 include, but are not limited to, Titankote™ C10, C11, and/or C14, which are available from Richter Precision, Inc. in East Petersburg, Pa.

Other examples of coatings that can be applied to the camera head 116 and/or the probe tip 118 include tungsten disulfide, PTFE (e.g., Teflon®), Symcoat ENT, Symcoat Entecoat, Tiodize® T1, Tiodize® T2, Anolube®, Dichronite®, TechCoat DLA 200, etc.

### Examples

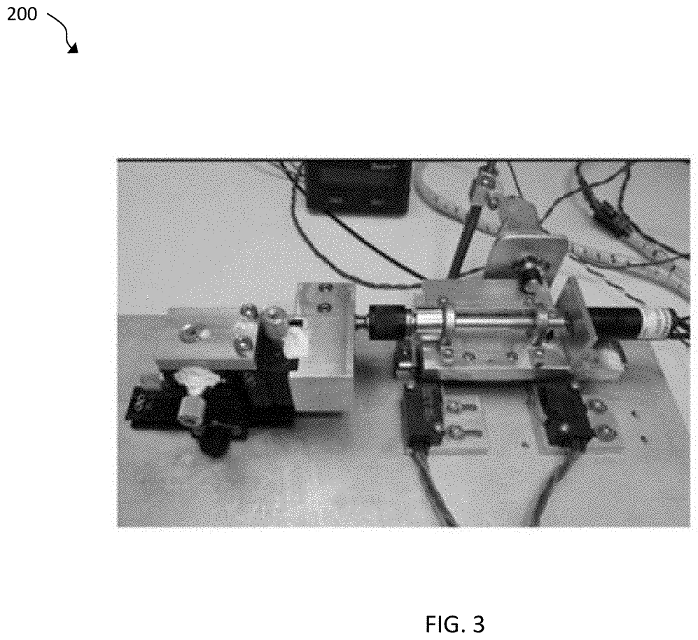

The effectiveness of various combinations of materials and coatings used for camera heads (e.g., camera head 116) and probe tips (e.g., probe tip 118) were tested using a testing system. FIG. 3 shows an example of a testing system 200 that was used to test thread wear for various combinations of materials and coatings. The testing system is configured to repeatedly thread a probe tip onto a camera head and subsequently unthread the probe tip from the camera head. One threading and unthreading represents one cycle. The probe tip was threaded onto, and unthreaded from, the camera head until failure. Failure can be described as a condition in which the threads (e.g., threads 122) of the camera head are worn to the point that the probe tip can no longer be threaded onto the camera head.

Several combinations of materials and coatings for camera heads and the probe tips were tested using the testing system 200 shown in FIG. 3. Table 2 shows experimental results for various combinations of materials and coatings that were tested.

TABLE 2
Experimental results for various combinations of materials and coating used for
camera heads and probe tips.

| | | | Probe | | |
|---|---|---|---|---|---|
| | | Head | Tip | Probe Tip | Avg. cycles |
| Combination | Head Material | Coating | Material | Coating | until failure |
| 1 | TiAl₆V₄ | None | 303 SS | None | 699 |
| 2 | TiAl₆V₄, anodized | Slickote ® | 303 SS | None | 8529 |
| | | DL100 | | | |
| 3 | TiAl₆V₄, anodized | Slickote ® | 303 SS | Titankote ™ | 67587 |
| | | DL100 | | C12 | |
| 4 | TiAl₆V₄, nitrided | None | 303 SS | None | 1500 |
| 5 | TiAl₆V₄ | Titankote ™ | 303 SS | None | 3906 |
| | | C12 | | | |
| 6 | TiAl₆V₄ | None | 303 SS | Titankote ™ | 5381 |
| | | | | C12 | |
| 7 | TiAl₆V₄ | Tungsten | 303 SS | None | 789 |
| | | Disulfide | | | |
| 8 | TiAl₆V₄, anodized | None | 303 SS | None | 1186 |
| 9 | TiAl₆V₄ | Symcoat | 303 SS | None | 5165 |
| | | ENT | | | |
| 10 | TiAl₆V₄ | Symcoat | 303 SS | None | 3549 |
| | | Entecoat | | | |
| 11 | Bronze-Aluminum | None | 303 SS | None | 2504 |
| | mixture | | | | |
| 12 | TiAl₆V₄ | Tiodize ® | 303 SS | None | 2365 |
| | | T2 | | | |
| 13 | TiAl₆V₄ | Slickote ® | 303 SS | None | 2226 |
| | | DL100 | | | |
| 14 | TiAl₆V₄ | Tiodize ® | 303 SS | None | 2120 |
| | | T1 | | | |
| 15 | Bronze-Aluminum | None | Ti | None | 1583 |
| | mixture | | | | |
| 16 | TiAl₆V₄, anodized | Titankote ™ | 303 SS | Slickote ® | 48020 |
| | | C12 | | DL100 | |
| 17 | TiAl₆V₄ | dichronite | 303 SS | None | 1298 |
| 18 | TiAl₆V₄ | Slickote ® | 304 SS | None | 841 |
| | | DL100 | | | |
| 19 | TiAl₆V₄ | TechCoat | 304 SS | None | 755 |
| | | DLA 200 | | | |
| 20 | TiAl₆V₄, heat treated | None | 304 SS | None | 600 |
| | to 39 HRC | | | | |
| 21 | TiAl₆V₄, anodized | None | 304 SS | Slickote ® | 600 |
| | | | | DL100 | |
| 22 | TiAl₆V₄ | None | 304 SS | Anolube ® | 500 |
| 23 | TiAl₆V₄, anodized | None | 304 SS | Dichronite | 400 |
| 24 | TiAl₆V₄ | None | 304 SS | None | 500 |
| | | | heat | | |
| | | | treated to | | |
| | | | 39 HRC | | |

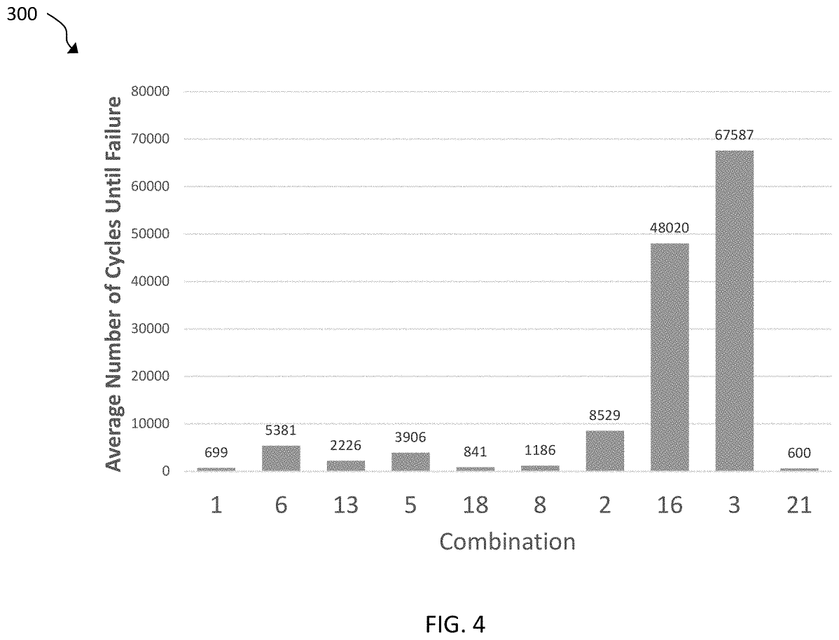

FIG. 4 shows a plot 300 that illustrates average numbers of cycles until failure for various combinations of materials and coatings shown in Table 2. The plot 300 shows data corresponding to combinations that include a TiAl₆V₄ camera heads and a stainless steel probe tip. The camera heads and/or the probe tips were uncoated, coated with Slickote® DL100, and/or coated with Titankote™ C12.

Combination 1 was tested to generate a baseline of performance. Combination 1 included an uncoated camera head made of TiAl₆V₄ and an uncoated probe tip made of 303 SS. Combination 1 resulted in an average of 699 cycles until failure.

Combination 6 included an uncoated camera head made of TiAl₆V₄ with a probe tip made of 303 SS and coated with Titankote™ C12. Combination 6 resulted in an average of 5381 cycles until failure. As compared to combination 1, the application of the coating of Titankote™ C12 on the 303 SS probe tip increased the average number of cycles until failure by 4,682 cycles.

Combination 13 included a camera head made of TiAl₆V₄ and coated with Slickote® DL100 with an uncoated probe tip made of 303 SS. Combination 13 resulted in an average of 2226 cycles until failure. As compared to combination 1, the application of the coating of Slickote® DL100 on the TiAl₆V₄ camera head increased the average number of cycles until failure by 1,527 cycles. However, combination 6 increased the average number of cycles until failure by 3,155 more cycles than combination 13.

Combination 5 included a camera head made of TiAl₆V₄ and coated with Titankote™ C12 with an uncoated probe tip made of 303 SS. Combination 5 resulted in an average of 3906 cycles until failure. As compared to combination 1, the application of the coating of Titankote™ C12 on the TiAl₆V₄ camera head increased the number of cycles until failure by 3207. However, combination 6, which included the coating of Titankote™ C12 on the probe tip, increased the number of cycles until failure by 1,475 more cycles than combination 5, which included Titankote™ C12 on the camera head.

Combination 18 included a camera head made of TiAl₆V₄ and coated with Slickote® DL100 with an uncoated probe tip made of 304 SS. Combination 18 resulted in an average of 841 cycles until failure. As compared to the baseline combination 1, the application of the coating of Slickote® DL100 on the TiAl₆V₄ camera head, with the use of the 304 SS probe tip, increased the average cycled until failure by 142 cycles. Combination 18 increased the number of cycles until failure by 1,385 fewer cycles than combination 13, which included the 303 SS probe tip. As described above, 304 SS is similar to 303 SS, but 304 SS has a lower hardness than 303 SS. The results of the combination 18 as compared to the results of combination 13 indicate that it may be preferable to have a probe tip made of a harder material.

Combination 8 was tested as another baseline combination. Combination 8 included an uncoated camera head made of anodized TiAl₆V₄ with an uncoated probe tip made of 303 SS. Combination 8 resulted in an average of 1186 cycles until failure. As compared to combination 1, anodizing the TiAl₆V₄ camera head increased the number of cycles until failure by 487 cycles.

Combination 2 included a camera head made of anodized TiAl₆V₄ and coated with Slickote® DL100 with an uncoated probe tip made of 303 SS. Combination 2 resulted in an average of 8529 cycles until failure. As compared to combination 8, the application of the coating of Slickote® DL100 on the anodized TiAl₆V₄ camera head increased the average number of cycles until failure by 7,343 cycles.

Combination 16 included a camera head made of anodized TiAl₆V₄ and coated with Titankote™ C12 and a probe tip made of 303 SS and coated with Slickote® DL100. Combination 16 resulted in an average of 48,020 cycles until failure. As compared to combination 8, the application of the coating of Titankote™ C12 on the anodized TiAl₆V₄ camera head with the coating of Slickote® DL100 on the 303 SS probe tip increased the average number of cycles until failure by 46,834 cycles. The anodized TiAl₆V₄ camera head in conjunction with the application of the coating of Slickote® DL100 on the 303 SS probe tip in combination 16 increased the number of cycles until failure by more than a factor of five as compared to the results of combination 5, which included a the Titankote™ C12 on a TiAl₆V₄ camera head but did not include a coating of Slickote® DL100 on the 303 SS probe tip. Accordingly, the application of the coating of Slickote® DL100 on the 303 SS probe tip in conjunction with anodizing the TiAl₆V₄ camera head and coating the camera head with Titankote™ C12 can significantly reduce wear of the threads of the camera head, thereby increasing the lifespan of an imaging system (e.g., a borescope) that uses combination 16.

Combination 3 included a camera head made of anodized TiAl₆V₄ and coated with Slickote® DL100 and a probe tip made of 303 SS and coated with Titankote™ C12.

Combination 3 resulted in an average of 67,587 cycles until failure. As compared to combination 8, the application of the coating of Slickote® DL100 on the anodized TiAl₆V₄ camera head with the coating of Titankote™ C12 on the 303 SS probe tip increased the average number of cycles until failure by 59,058 cycles. The application of the coating of Titankote™ C12 on the 303 SS probe tip in combination 3 increased the number of cycles until failure by almost a factor of eight as compared to the results of combination 2, which included the Slickote® DL100 on the anodized TiAl₆V₄ camera head but did not include a coating of Titankote™ C12 on the 303 SS probe tip. Accordingly, the application of the coating of Titankote™ C12 on the 303 SS probe tip in conjunction with the coating of Slickote® DL100 on the anodized TiAl₆V₄ camera head can significantly reduce wear of the threads of the camera head, thereby increasing the lifespan of an imaging system (e.g., a borescope) that uses combination 3.

Combination 21 included an uncoated camera head made of anodized TiAl₆V₄ with a probe tip made of 304 SS and coated with Slickote® DL100. Combination 21 resulted in an average of 600 cycles until failure. As compared to the combinations 1 and 8, respectively, combination 21 resulted in 99 and 586 fewer cycles until failure.

Exemplary technical effects of the subject matter described herein include the ability to significantly reduce wear of threads of a camera head of an imaging system (e.g., a borescope), thereby increasing the lifespan of an imaging system. By using a camera head made of anodized TiAl₆V₄ and coated with a SFL in combination with a probe tip made of 303 SS and coated with a DLC, wear on threads of the camera head can be reduced, thereby increasing the lifespan of the imaging system. As another example, using a camera head made of anodized TiAl₆V₄ and coated with a DLC in combination with a probe tip made of 303 SS and coated with a SFL, wear on threads of the camera head can be reduced, thereby increasing the lifespan of the imaging system

One skilled in the art will appreciate further features and advantages of the subject matter described herein based on the above-described embodiments. Accordingly, the present application is not to be limited specifically by what has been particularly shown and described. All publications and references cited herein are expressly incorporated herein by reference in their entirety.

Other embodiments are within the scope and spirit of the disclosed subject matter. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. An imaging apparatus, comprising:
a housing with an elongate body extending distally therefrom, the elongate body including a camera head at a distal end thereof with a camera therein configured to obtain images, the camera head including threads;
at least one probe tip with threads configured to threadably mate with threads on the camera head for removably mating the probe tip to the camera head; and
a diamond-like carbon coating on the threads of the probe tip.

2. The apparatus of claim 1, further comprising a solid film lubricant coating on the threads of the camera head.

3. The apparatus of claim 2, wherein the solid film lubricant coating comprises a heat cured, resin bonded solid film lubricant coating.

4. The apparatus of claim 2, wherein the solid film lubricant coating comprises Slickote® DL100.

5. The apparatus of claim 1, wherein a body of the camera head is at least partially coated with a solid film lubricant.

6. The apparatus of claim 1, wherein the threads of the camera head are formed from anodized titanium alloy.

7. The apparatus of claim Error! Reference source not found, wherein the anodized titanium alloy comprises TiAl₆V₄.

8. The apparatus of claim 1, wherein the diamond-like carbon coating comprises a metal-containing coating.

9. The apparatus of claim 1, wherein the diamond-like carbon coating comprises Titankote™ C12.

10. The apparatus of claim 1, wherein the diamond-like carbon coating has a thickness in a range of about 1 μm to 5 μm.

11. The apparatus of claim 1, wherein a body of the probe tip is at least partially coated with a diamond-like carbon coating.

12. The apparatus of claim 1, wherein the threads of the probe tip are formed from stainless steel.

13. The apparatus of claim 12, wherein the stainless steel comprises 303 stainless steel.

14. The apparatus of claim 1, wherein the threads of the camera head are formed from anodized titanium alloy, and wherein the threads of the probe tip are formed from stainless steel, and further comprising a solid film lubricant coating on the threads of the camera head.

15. The apparatus of claim 1, wherein the threads of the camera head are formed on an external surface of the camera head, and the threads of the probe tip are formed within a lumen in the probe tip, and wherein the lumen in the probe tip is configured to receive at least a portion of the camera head therein.

16. An imaging system, comprising:
a housing with an elongate body extending distally therefrom with a camera head at a distal end thereof, the camera head including an imaging device configured to acquire images and to transmit data characterizing the images, and the housing including a controller configured to control operation of the imaging device; and
at least one probe tip detachably mateable to the camera head;
wherein the camera head has anodized titanium alloy threads that engage corresponding stainless steel threads on the probe tip, and wherein threads on the camera head are coated with a solid film lubricant coating and the threads on the probe tip are coated with a diamond-like carbon coating.

17. The system of claim 16, wherein the anodized titanium alloy threads are formed from a titanium alloy that includes titanium, aluminum, and vanadium.

18. The system of claim 16, wherein the stainless steel threads comprise 303 stainless steel.

19. The system of claim 16, wherein the diamond-like carbon coating comprises Titankote™ C12.

20. The system of claim 16, wherein the solid film lubricant coating comprises Slickote® DL100.
